(19) United States
(12) Patent Application Publication
(10) Pub. No.: US 2020/0295477 A1
(43) Pub. Date: Sep. 17, 2020

(54) Connection Arrangement, Contact Element and Method for Producing a Connection

(71) Applicant: Rosenberger Hochfrequenztechnik GmbH & Co. KG, Fridolfing (DE)

(72) Inventor: Andreas Gruber, Ainring (DE)

(21) Appl. No.: 16/806,231

(22) Filed: Mar. 2, 2020

(30) Foreign Application Priority Data
Mar. 12, 2019 (EP) 19 162 166.3

(51) Int. Cl. H01R 9/05; H01R 4/18; H01R 4/20

(52) U.S. Cl. CPC H01R 9/0518; H01R 4/20; H01R 4/187

(57) ABSTRACT

A connection arrangement comprising an electrical cable and a contact element connected to a free end of an electrical conductor of the cable, wherein a first end section of the contact element penetrates an end face of the free end of the electrical conductor, and at least one region of the first end section of the contact element is directly connected to the electrical conductor with a material bond.

### RELATED APPLICATIONS

This US National Phase patent application claims priority to European Patent Application No. EP 19 162 166.3 which was filed on 12 Mar. 2019. The entire contents of the aforementioned European Patent Application is expressly and fully incorporated herein by this reference.

### BACKGROUND

The invention relates to a connection arrangement, comprising an electrical cable and a contact element connected to a free end of an electrical conductor of the cable, according to the precharacterizing clause of claim 1.

The invention further relates to a contact element for connection to a free end of an electrical conductor of an electrical cable according to the precharacterizing clause of claim 9.

The invention also relates to an electrical plug connector comprising a connection arrangement.

In addition, the invention relates to a method for producing a connection between an electrical conductor of an electrical cable and a contact element according to the precharacterizing clause of claim 11.

Finally, the invention also relates to an apparatus for producing a connection arrangement according to the precharacterizing clause of claim 15.

Contact elements are used to make contact with an electrical conductor of an electrical cable. The contact elements may be, in particular, contact elements of a plug connector which are provided for the purpose of making contact with a further plug connector (also referred to as “mating plug connector” below).

For example, it is known practice to connect the inner conductor of a coaxial cable to an inner conductor contact element of a coaxial plug connector by means of a soldered or crimp connection.

However, these connection technologies are associated with mechanical and electrical disadvantages. For example, the process time required for soldering reduces the throughput when producing the plug connectors, which can be uneconomical, in particular within the scope of mass production. Furthermore, the additional production means (for example solder or a crimp sleeve) increase the costs during production. With regard to a soldering process, the necessary heat input into the connection arrangement may also be problematic.

US 2016/0079688 A1, forming the generic background, discloses a coaxial plug connector in which, in order to make contact with the inner conductor of a coaxial cable, a press pin of a two-part inner conductor contact element is introduced into an end-face hole in the inner conductor. The outer diameter of the press pin and the inner diameter of the hole in the inner conductor of the cable are designed in this case in such a manner that the press pin radially widens the inner conductor as a result of its penetration, thus resulting in a press-fit between the inner conductor of the cable and a sleeve surrounding the inner conductor. The press-fit therefore forms a force-fitting connection between the inner conductor of the cable and the inner conductor contact element. The connection arrangement disclosed in US 2016/0079688 A1 is therefore able to circumvent some of the above-mentioned disadvantages of the conventional soldered or crimp connections.

However, the hole required in the inner conductor of the cable can be introduced only with difficulty in terms of production. Furthermore, the solution in US 2016/0079688 A1 requires a two-part structure of the contact element, which in turn increases the logistics costs.

Finally, the plug connection disclosed in US 2016/0079688 A1 is also not readily suitable for radio-frequency technology since the sudden change in diameter on account of the sleeve applied to the inner conductor can result in an impedance mismatch.

In view of the known prior art, the object of the present invention is to provide an improved connection arrangement which is simple to produce and the electrical properties of which are suitable, in particular, for use in radio-frequency technology.

The present invention is also based on the object of providing an improved contact element for connection to an electrical conductor of an electrical cable, which contact element is simple to produce and has electrical properties which are advantageous for radio-frequency technology, in particular.

The object of the invention is also to provide an electrical plug connector which has an improved connection arrangement.

Finally, the object of the invention is also to provide an advantageous method and an apparatus for producing a connection between an electrical conductor of an electrical cable and a contact element, which at least reduces the known disadvantages of the prior art.

The dependent claims and the features described below relate to advantageous embodiments and variants of the invention.

A connection arrangement is provided, comprising an electrical cable and a contact element connected to a free end of an electrical conductor of the cable. A first end section of the contact element penetrates an end face of the free end of the electrical conductor.

It is therefore possible to produce an electrical and mechanical connection between the contact element and the electrical conductor, preferably an inner conductor of an electrical cable.

The first end section of the contact element preferably penetrates the electrical conductor along an axial direction with respect to the longitudinal axis of the electrical conductor.

The contact element according to the invention can also be referred to as a “pin”.

The free end of the electrical conductor may be, in particular, a plug-side end of the electrical conductor which is intended to be connected to the contact element of a plug connector.

The electrical conductor is preferably formed from copper or aluminum.

The invention provides for at least one region of the first end section of the contact element to be directly connected to the electrical conductor with a material bond.

Within the scope of the invention, a “direct connection with a material bond” should be understood as meaning the fact that the connection with a material bond between the first end section of the contact element and the electrical conductor is effected without the aid of a further material. In particular, no welding or soldering additives (for example solder) are provided for the direct connection with a material bond. A connection to the electrical conductor with a material bond is therefore provided in at least one region of the first end section of the contact element without using welding or soldering additives. No adhesive or the like is preferably provided for the direct connection with a material bond either.

The connection with a material bond is preferably a connection with a material bond which was produced without supplying external heat or without using external heat sources (for example laser, induction furnace etc.). The connection with a material bond is particularly preferably produced by frictional heat when introducing the contact element into the electrical conductor.

The region of the first end section of the contact element is preferably directly connected to an inner section of the electrical conductor with a material bond at least in certain regions. However, provision may also made for the first end section to directly make contact with the end face of the electrical conductor with a material bond at least in certain regions.

A plurality of regions of the first end section of the contact element are preferably directly connected to the electrical conductor with a material bond. The first end section of the contact element is particularly preferably at least approximately completely, and very particularly preferably completely, directly connected to the electrical conductor with a material bond.

It is therefore possible to advantageously dispense with additional production means, for example an additional solder.

One development of the invention may provide for the contact element to be connected to the free end of the electrical conductor in such a manner that the contact element does not make contact with an outer circumference of the electrical conductor.

It is therefore possible to dispense with a crimp sleeve or another sleeve for mechanically connecting the contact element to the electrical conductor, for example.

The joining region of the connection arrangement can be very small in comparison with the prior art, in particular since it is possible to dispense with additional production means and a sleeve for pressing the electrical conductor to the contact element.

An (electrical and mechanical) connection or contact connection of the first end section of the contact element to the electrical conductor can be provided solely in the interior of the electrical conductor. However, provision may also be optionally made for the first end section of the contact element to make contact with the end face of the free end of the electrical conductor.

As a result of the fact that it is possible to dispense with a contact connection on the outer circumference of the electrical conductor, for example by means of a sleeve, an electrical plug connector equipped with the connection arrangement can be smaller. At the same time, on account of the fact that a sudden change in diameter is avoided in the connection region, an advantageous use of the connection arrangement in radio-frequency technology can be enabled without the need for complicated impedance matching operations.

One advantageous development of the invention may provide for the electrical conductor to be in the form of an inner conductor of the cable and for the contact element to be in the form of an inner conductor contact element of a plug connector.

The plug connector may be, for example, a plug, a socket, a coupler or an adapter. The designation “plug connector” used within the scope of the invention is representative of all variants.

In one configuration of the invention, the electrical cable can be in the form of a coaxial cable.

The coaxial cable may have a single inner conductor which is encased by a dielectric and is finally surrounded by an outer conductor in order to electromagnetically shield the inner conductor.

The invention can preferably be used with a so-called corrugated cable. The corrugated cable may have, in particular, a corrugated sheath made of copper, a dielectric made of PE foam and an inner conductor made of aluminum.

However, the invention is also suitable for use with other cables. For example, an unshielded electrical cable can also be provided.

Within the scope of the invention, it is also possible to provide electrical cables having more than one inner conductor, for example twisted-pair cables with twisted pairs of wires or parallel-pair cables or other multi-core cables. Provision can then be made for at least one of the wires or one of the inner conductors to be connected to a contact element according to the invention, preferably for all wires or inner conductors to be connected to a respective contact element according to the invention.

One configuration of the invention may provide for the contact element to be formed in one part.

The first end section of the contact element, which is provided for mechanical and electrical connection to the electrical conductor, can preferably be formed in one part with the rest of the contact element. It is therefore possible to dispense with a multi-component solution, for example a sleeve surrounding the first end section.

In addition to the first end section for connection to the electrical conductor, the contact element may have a second end section which is arranged at the other end of the contact element. The second end section can be designed for connection to a contact element of a mating plug connector or for connection to another electrical component, for example a component on an electrical printed circuit board. A middle section of the contact element can be optionally provided between the first end section and the second end section, for example for the purpose of mechanically fixing the contact element in a plug connector housing.

One development of the invention may provide for the outer diameter of the contact element to correspond to the outer diameter of the electrical conductor at least in a middle section adjoining the first end section of the contact element. Provision may also be made for the outer diameter of the contact element to correspond to the outer diameter of the electrical conductor in its second end section.

As a result of the fact that there is no need to change the diameter at the transition point when fastening the contact element to the electrical conductor, an impedance jump can be avoided. An additional impedance matching operation of the connection arrangement can therefore be simplified or even omitted. A plug connector equipped with a corresponding connection arrangement can be smaller than the known plug connectors of the prior art and is simultaneously well suited to radio-frequency technology.

One configuration of the invention may provide for an outer conductor contact element surrounding the contact element, for example an outer housing of a plug connector, to have a constant cross section in an axial section which radially surrounds the end section of the contact element.

In particular, if the outer diameter of the contact element corresponds to the outer diameter of the electrical conductor in a middle section adjoining the first end section of the contact element, a change in the cross section of the outer conductor contact element which is required during a conventional impedance matching operation can possibly be omitted.

The configuration possibilities for an accordingly equipped plug connector can therefore be increased.

One development of the invention may provide for the connection between the first end section of the contact element and the free end of the electrical conductor to be a cold-welded connection, preferably a gas-tight connection.

As a result, generally only locally limited heating occurs during the production of the connection arrangement—possibly harmful heat input can be avoided. Furthermore, a gas-tight connection can be suitable, in particular, for providing robust plug connectors which can be safely and durably used even under adverse conditions of use, for example in vehicles.

One advantageous configuration of the invention may provide for the connection between the first end section of the contact element and the free end of the electrical conductor to comprise a form-fitting connection.

Within the scope of the invention, in addition to the direct connection with a material bond in certain regions, a form-fitting connection between the first end section of the contact element and the free end of the electrical conductor may also be advantageous.

One development of the invention may provide for the cross section of the first end section to taper in the direction of the free end of the first end section.

Tapering of the cross section of the first end section in the direction of its free end can be particularly well suited to producing the connection since the contact element can then be introduced in a comparatively simple manner into the free end of the electrical conductor in the manner of a wedge.

One configuration of the invention may provide for the first end section of the contact element to be conically shaped.

In particular, the first end section of the contact element can be conically shaped such that the cross section or diameter of the first end section decreases or tapers in the direction of the free end of the first end section.

A conical shape of the penetration region or of the first end section of the contact element can facilitate complete penetration of the first end section of the contact element into the interior of the electrical conductor.

A conical geometry can also produce a comparatively large amount of friction when joining the first end section of the contact element to the electrical conductor and can therefore facilitate a material bond.

One configuration of the invention may provide for the free end of the first end section of the contact element to have a tip or a curvature.

In particular with regard to the method also described below for producing the connection arrangement, a tip or a curvature can be advantageous in order to advantageously introduce the first end section into the electrical conductor.

One advantageous development of the invention may provide for the first end section of the contact element to have at least one radial shoulder, preferably at least one radial cutting edge and/or an undercut.

Radial shoulders in the first end section, behind which displaced material of the electrical conductor can accumulate, can be particularly well suited to optimized form-fitting fastening. A radial edge can form an undercut, for example, and can thereby hook into the electrical conductor.

Cutting edges and/or undercuts can also be particularly well suited to deliberately abrading material of the electrical conductor from the electrical conductor in certain regions when introducing the first end section, which material can then accumulate behind the undercut. A cutting edge makes it possible, in particular, to produce a metal chip which is severed completely or at least in certain regions and then at least partially fills the recess of an undercut and can hereby enable or optimize a form-fitting connection. The metal chip can also facilitate an additional material bond.

One development of the invention may provide for the first end section of the contact element to have a coating. In particular, provision may be made for the coating to consist of a material which facilitates a connection with a material bond.

For example, it is possible to provide a coating made of a material with a lower melting temperature than that of the material of the contact element and that of the material of the electrical conductor. However, the melting temperature of the material of the coating may also be higher than the melting temperature of the material of the contact element and that of the material of the electrical conductor.

A coating of the first end section of the contact element can facilitate, for example, the penetration of the first end section into the electrical conductor. In addition, the mechanical connection and the electrical connection can be improved by means of a coating.

In this manner, locally occurring heating of the contact element can be used during penetration of the first end section into the electrical conductor.

For example, it is possible to provide a coating made of silver or made of a material with a similar melting temperature and comparable electrical properties. The electrical conductor can then preferably be formed from aluminum or a material with a similar melting temperature and comparable electrical properties.

The invention also relates to a contact element for connection to a free end of an electrical conductor of an electrical cable, having a contact body with a first end section, wherein the first end section is configured to penetrate an end face of the free end of the electrical conductor. The contact element is designed in such a manner that at least one section of the first end section of the contact body can be directly connected to the first conductor with a material bond.

For this purpose, provision may be made, for example, for the contact element to not have a sleeve (for example a pressing sleeve) in order to make contact with and press the outer circumference of the electrical conductor. Such a sleeve would result in the contact element becoming stuck to the electrical conductor during the penetration of the contact element into the electrical conductor, as a result of which it is not possible to achieve a sufficiently high pressure or a sufficiently high relative velocity to directly connect the contact element to the electrical conductor with a material bond.

The contact body can be designed in such a manner that it does not make contact with an outer circumference of the electrical conductor when the first end section of the contact body is connected to the electrical conductor.

The contact element can preferably have a specific tip geometry in its first end section in order to be able to advantageously penetrate the end face of the free end of the electrical conductor.

The invention also relates to an electrical plug connector comprising a connection arrangement according to the embodiments above and below.

The invention preferably relates to an electrical plug connector comprising a connection arrangement having an electrical cable and a contact element connected to a free end of the electrical conductor of the cable, wherein a first end section of the contact element penetrates the electrical conductor in the axial direction with respect to the longitudinal axis of the electrical conductor. In this case, provision may be made for at least one region of the first end section of the contact element to be directly connected to the electrical conductor with a material bond. The contact element is preferably connected to the free end of the electrical conductor in such a manner that the contact element does not make contact with an outer circumference of the electrical conductor.

The invention is not restricted to a specific design of a plug connector or to a specific electrical cable. However, the invention is particularly suitable for electrical cables and cable plug connectors for radio-frequency technology, in particular for use in communication technology and/or in vehicles. The use of the invention with cable plug connectors in the high-voltage range can also be advantageous.

A cable plug connector according to the invention may be, for example, in the form of a PL plug connector, a BNC plug connector, a TNC plug connector, an SMBA (FAKRA) plug connector, an N plug connector, a 7/16 plug connector, an SMA plug connector, an SMB plug connector, an SMS plug connector, an SMC plug connector, an SMP plug connector, a BMS plug connector, an HFM plug connector, an HSD plug connector, an H-MTD plug connector, a BMK plug connector, a mini-coax plug connector or a Makax plug connector. It is to be understood the above identified plug connectors are examples of plug connectors only, and the invention herein is not limited to these identified examples of plug connectors.

The invention also relates to a method for producing a connection between an electrical conductor of an electrical cable and a contact element, according to which a first end section of the contact element is introduced into an end face of a free end of the electrical conductor. In this case, provision is made for the first end section of the contact element to be introduced into the free end of the electrical conductor with such a high pressure and/or at such a high relative velocity that the first end section of the contact element and the electrical conductor are connected to one another with a material bond at least in certain regions as a result of the high pressure and/or the high relative velocity.

A person skilled in the art can determine the “high pressure” and the “high relative velocity” in an application-specific manner in order to produce a direct material bond between the components on the basis of the materials used for the electrical conductor and the contact element.

The first end section of the contact element is preferably introduced or inserted into the free end of the electrical conductor at such a velocity that a cold-welded connection is produced between the first end section and the electrical conductor.

It is therefore possible to provide a method for producing a join between a contact element and an electrical conductor, in which complicated plug-in contacts, thermal welding methods, ultrasonic welding or soldering is preferably dispensed with when producing the connection.

One development of the invention may provide for the high relative velocity to be based on a high linear velocity and/or a high angular velocity.

In particular, provision may be made for the contact element to be introduced (for example inserted) into the electrical conductor at a high linear velocity. Alternatively or additionally, provision may also be made for the electrical conductor to be pushed over the contact element at a high linear velocity. A rotary movement can be superimposed on a high (relative) linear velocity.

Provision may also be made for the contact element to be introduced into the electrical conductor at a high angular velocity at any desired, preferably slow, feed rate or slow (relative) linear velocity.

Superimposing a rotary movement on the axial movement can be advantageous in order to also increase the local heating occurring when introducing the contact element into the electrical conductor in order to optimize a connection with a material bond.

In particular, if the first end section of the contact element is provided with a coating or additional solder is introduced into the connection in a conventional manner, a rotary movement may be advantageous in order to produce frictional heat.

Provision may preferably be made for the contact element to be introduced into the free end of the electrical conductor in such a manner that the contact element does not make contact with an outer circumference of the electrical conductor if the first end section is in its end position in the electrical conductor.

The first end section of the contact element can preferably be introduced into the end face of the electrical conductor in such a manner that a gas-tight connection is produced. A cold-welding method can be particularly preferably provided in order to connect the contact element to the electrical conductor.

One development of the invention may provide for the free end of the electrical conductor to form a completely closed end face which is penetrated by introducing the first end section of the contact element.

The end face of the electrical conductor preferably does not have a hole.

As a result of the fact that the free end of the electrical conductor first of all forms a completely closed end face, it is possible to dispense with making a hole in the end face, which greatly simplifies the production of the connection. In this context, the unprocessed end face of an electrical conductor in the form of a litz wire is also intended to fall under the term “completely closed end face”.

In principle, however, provision may also be made for the free end of the electrical conductor to have, on the end face, a centering hole, the diameter of which is greater than its hole depth.

One configuration of the invention may provide for the first end section of the contact element to be introduced into the free end of the electrical conductor in such a manner that a form-fitting connection is additionally produced.

A form-fitting connection and/or an indirect connection with a material bond is/are preferably provided in addition to the direct connection with a material bond in certain regions.

One configuration of the invention may provide for the first end section of the contact element to be introduced into the free end of the electrical conductor in such a manner that the contact element strikes the end face of the free end of the electrical conductor with a radial return.

The first end section of the contact element is preferably introduced into the free end of the electrical conductor in such a manner that the first end section is completely inside the electrical conductor if the contact element is in its axial end position in the electrical conductor.

One configuration of the invention may provide for a velocity of at least 5 m/s, preferably at least 10 m/s, particularly preferably at least 20 m/s, more preferably at least 30 m/s, and very particularly preferably at least 40 m/s, to be provided as the high relative velocity.

The above-mentioned velocity ranges have been found to be particularly suitable.

An acceleration of the contact element in order to reach a corresponding velocity can preferably be carried out pneumatically. However, a mechanical solution, for example the prestressing and releasing of a spring, can also be provided. Furthermore, it is possible to use an electromagnetic or electrodynamic solution, for example using the Lorentz force to accelerate the contact element. A chemical or thermodynamic (for example pyrotechnic) solution, for example a controlled explosion, can also be provided. Finally, it is also possible to use the gravitational force by means of a “free-fall apparatus” in order to sufficiently accelerate the contact element. Combinations of the above-mentioned variants are also possible.

The invention also relates to an apparatus for producing a connection arrangement according to the embodiments above and below. The apparatus has means in order to introduce the first end section of the contact element into an end face of the free end of the electrical conductor with a material bond at least in certain regions at high velocity and/or with high mechanical force.

On account of the high velocity and/or the high force, a connection with a material bond can result between the first end section of the contact element and the electrical conductor on account of the friction. However, in contrast to friction welding, there is generally no high heating of the connection, apart from local heating in the micro-range.

A contact element having a first end section for connection to the free end of the electrical conductor can be advantageously inserted into the end face of the electrical conductor by means of the apparatus and can be connected to said conductor as a result. The high velocity can produce a connection with a material bond.

One advantageous development of the invention may provide for the means to be in the form of pneumatic, electromagnetic, pyrotechnic or gravitation-based means, or for a means driven by spring force to be provided in order to insert the first end section of the contact element into the end face of the free end of the electrical conductor.

In principle, any desired means can be provided in order to introduce the first end section into the end face of the free end of the electrical conductor. The means mentioned should be understood merely as an example.

It goes without saying that features which have been described in connection with the connection arrangement according to the invention can also be advantageously implemented for the contact element according to the invention, the electrical plug connector, the method and the apparatus, and vice versa. Furthermore, advantages which have already been mentioned in connection with the connection arrangement according to the invention can also be understood as relating to the contact element according to the invention, the electrical plug connector, the method and the apparatus, and vice versa.

It shall be additionally pointed out that terms such as “comprising”, “having” or “with” do not exclude any other features or steps. Furthermore, terms such as “one” or “the”, which refer to steps or features in the singular, do not exclude a plurality of features or steps, and vice versa.

### SUMMARY

A connection arrangement comprising an electrical cable and a contact element connected to a free end of an electrical conductor of the cable, wherein a first end section of the contact element penetrates an end face of the free end of the electrical conductor, and at least one region of the first end section of the contact element is directly connected to the electrical conductor with a material bond.

A first aspect of the present invention is a connection arrangement comprising: an electrical cable having an electrical conductor; a contact element connected to a free end of the electrical conductor of the electrical cable, and wherein a first end section of the contact element penetrates an end face of the free end of the electrical conductor; and at least one region of the first end section of the contact element is directly connected to the electrical conductor with a material bond.

A second aspect of the present invention is a connection arrangement wherein the contact element is connected to the free end of the electrical conductor in such a manner that the contact element does not make contact with an outer circumference of the electrical conductor.

A third aspect of the present invention is a connection arrangement wherein the electrical conductor is in the form of an inner conductor of the cable, and the contact element is in the form of an inner conductor contact element of a plug connector.

A fourth aspect of the present invention is a connection arrangement wherein an outer diameter of the contact element corresponds to an outer diameter of the electrical conductor in a middle section adjoining the first end section of the contact element.

A fifth aspect of the present invention is a connection arrangement wherein the connection between the first end section of the contact element and the free end of the electrical conductor is a cold-welded connection.

A sixth aspect of the present invention is a connection arrangement wherein a cross section of the first end section tapers in the direction of the free end of the first end section.

A seventh aspect of the present invention is a connection arrangement wherein the first end section of the contact element has at least one radial shoulder.

An eighth aspect of the present invention is a connection arrangement further comprising a coating on the contact element.

A ninth aspect of the present invention is a contact element for connection to a free end of an electrical conductor of an electrical cable comprising: the contact element having a contact body with a first end section, and wherein the first end section is configured to penetrate an end face of the free end of the electrical conductor; and wherein at least one section of the first end section of the contact body is directly connected to the first conductor with a material bond.

A tenth aspect of the present invention is a method for producing a connection between an electrical conductor of an electrical cable and a contact element, the method comprising the steps: providing a contact element having a first end section, introducing the first end section of the contact element into an end face of a free end of the electrical conductor, and the introduction of the first end section of the contact element into the free end of the electrical conductor is accomplished with high pressure and high relative velocity so that the first end section of the contact element and the electrical conductor are connected to one another with a material bond, at least in certain regions, as a result of the high pressure and the high relative velocity.

An eleventh aspect of the present invention is a method wherein the high relative velocity is based on a high linear velocity and/or a high angular velocity.

A twelfth aspect of the present invention is a method wherein the contact element is introduced into the free end of the electrical conductor in such a manner that the contact element does not make contact with an outer circumference of the electrical conductor when the first end section is in position in the electrical conductor.

A thirteenth aspect of the present invention is a method wherein the free end of the electrical conductor forms a completely closed end face that is penetrated by introducing the first end section of the contact element.

A fourteenth aspect of the present invention is a method further comprising: introducing the first end section of the contact element into an end face of the free end of the electrical conductor with a material bond, at least in certain regions, at high velocity and/or with high mechanical force.

A fifteenth aspect of the present invention is a connection arrangement wherein the connection between the first end section of the contact element and the free end of the electrical conductor is a gas-tight connection.

A sixteenth aspect of the present invention is a connection arrangement wherein the first end section of the contact element has at least one radial cutting edge.

A seventeenth aspect of the present invention is a connection arrangement wherein the first end section of the contact element has at least one radial shoulder and an undercut.

An eighteenth aspect of the present invention is a method wherein the material bond created by introducing the first end section of the contact element into an end face of the free end of the electrical conductor is accomplished with high mechanical force.

A nineteenth aspect of the present invention is a method wherein the material bond created by introducing the first end section of the contact element into an end face of the free end of the electrical conductor is accomplished with high velocity and high mechanical force.

### BRIEF DESCRIPTION OF THE FIGURES

Exemplary embodiments of the invention are described in more detail below on the basis of the drawing.

The figures each show preferred exemplary embodiments in which individual features of the present invention are illustrated in combination with one another. Features of one exemplary embodiment can also be implemented in a manner detached from the other features of the same exemplary embodiment and can accordingly be readily combined with features of other exemplary embodiments by a person skilled in the art to form further useful combinations and sub-combinations.

In the figures, functionally identical elements are provided with the same reference signs.

In the drawings:

FIG. 1 schematically shows an electrical plug connector having a connection arrangement according to the prior art.

FIG. 2 schematically shows an electrical plug connector comprising a connection arrangement according to the invention.

FIG. 3 schematically shows a contact element according to the invention having a first end section according to a first embodiment with a rounded free end.

FIG. 4 schematically shows a contact element according to the invention having a first end section according to a second embodiment with a conical shaped tip.

FIG. 5 schematically shows a contact element according to the invention having a first end section according to a third embodiment with a tapering cross section.

FIG. 6 schematically shows a contact element according to the invention having a first end section according to a fourth embodiment with a tapering cross section.

FIG. 7 schematically shows a contact element according to the invention having a first end section according to a fifth embodiment with a tapering cross section.

FIG. 8 schematically shows a contact element according to the invention having a first end section according to a sixth embodiment with a radial shoulder.

FIG. 9 schematically shows a contact element according to the invention having a first end section according to a seventh embodiment with a radial shoulder.

FIG. 10 schematically shows a contact element according to the invention having a first end section according to an eighth embodiment with a radial shoulder.

FIG. 11 schematically shows a contact element according to the invention having a first end section according to a ninth embodiment with a radial cutting edge.

FIG. 12 schematically shows a detailed view of the cutting edge of the contact element from FIG. 11 in a simplified sectional illustration.

FIG. 13 schematically shows an apparatus for producing a connection arrangement.

### DETAILED WRITTEN DESCRIPTION OF THE PREFERRED EMBODIEMENTS

FIG. 1 shows a perspective sectional view of an electrical plug connector 100 according to the prior art. The electrical plug connector 100 has a connection arrangement 101 comprising an electrical cable 1, a corrugated cable in the exemplary embodiment, and a contact element 102 connected to a free end 2.1 of an electrical conductor 2, the inner conductor of the cable 1 in the present case. The electrical cable 1 has a dielectric 3 which encases the inner conductor or the electrical conductor 2 and electrically isolates it from an outer conductor 4 of the cable 1. The electrical plug connector 100 also has an electrically conductive outer housing 103 which is electrically connected to the outer conductor 4 of the electrical cable 1.

The connection arrangement 101 from the prior art is electrically and mechanically connected to the electrical conductor 2 or the inner conductor of the cable 1 by means of a soldered connection. For a sufficiently good connection and mechanical stability, the contact element 102 also encloses the free end 2.1 of the electrical conductor 2 on its outer circumference. The remaining intermediate space is filled with a solder. An alternative to a soldered connection can also be a crimp connection according to the prior art.

A further alternative known from the prior art may involve introducing the contact element 102 into an end face 2.2 of the free end 2.1 of the electrical conductor 2 along a hole (not illustrated) in order to displace the material of the electrical conductor 2 radially outward in order to produce a force-fitting connection to a sleeve encasing the electrical conductor 2.

In all of the variants mentioned, the problem arises of the production of the connection being comparatively complicated and a sudden change in diameter also being produced in the connection region. An impedance matching operation may become necessary on account of the changed cross section, which can considerably increase the dimensions of the plug connector 100 overall.

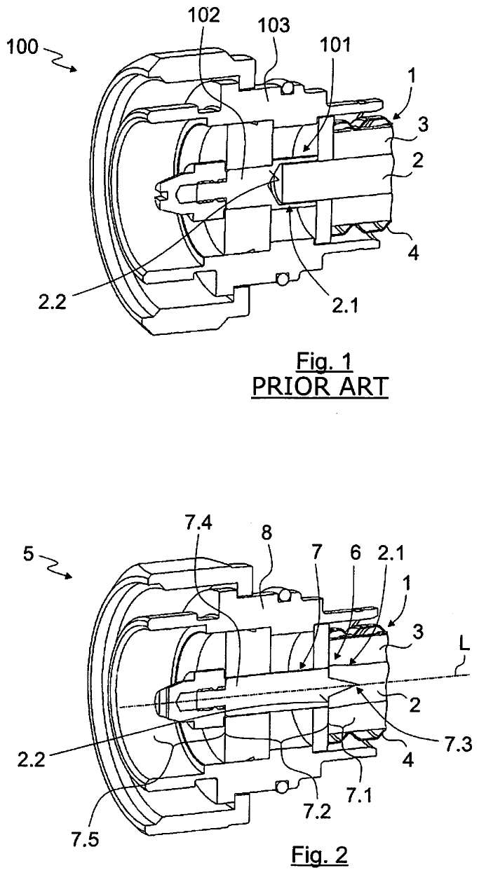

FIG. 2 shows an electrical plug connector 5 according to the invention comprising a connection arrangement 6 according to the invention. The electrical cable 1 corresponds, by way of example, to the corrugated cable already described within the scope of FIG. 1.

The first end section 7.1 of the contact element 7 according to the invention penetrates the end face 2.2 of the free end 2.1 of the electrical conductor 2 or of the inner conductor of the cable 1. In the exemplary embodiment, the contact element 7 is connected to the free end 2.1 of the electrical conductor 2 in such a manner that the contact element 7 does not make contact with an outer circumference of the electrical conductor 2. In particular, the contact body 7.4 of the contact element 7 does not make contact with the outer circumference of the electrical conductor 2.

A preferred use of the invention provides for the electrical conductor 2 to be in the form of an inner conductor of the cable 1 and for the contact element 7 to be in the form of an inner conductor contact element of the plug connector 5, as illustrated. The plug connector 5 may have an electrically conductive outer housing 8 and can have any desired design in principle. The exposed second end section 7.5 of the contact element can be designed to make contact with a contact element of a mating plug connector.

In contrast to the prior art, the contact element 7 can be advantageously formed in one part. It is possible to dispense with a sleeve or a sleeve-like projection of the contact element 102. It is also possible to dispense with the need to supply additional solder to the connection.

In order to avoid an impedance jump, it may be advantageous if the outer diameter of the contact element 7 corresponds to the outer diameter of the electrical conductor 2 in a middle section 7.2 adjoining the first end section 7.1 of the contact element 7. Finally, an outer conductor contact element surrounding the contact element 7, the electrically conductive outer housing 8 of the plug connector 5 in the present case, can have a constant cross section (not illustrated in the exemplary embodiment) in an axial section which radially surrounds the first end section 7.1 of the contact element 7.

The connection between the first end section 7.1 of the contact element 7 and the free end 2.1 of the electrical conductor 2 is a direct connection with a material bond at least in certain regions, that is to say a connection with a material bond without additional welding or soldering additives. It is preferably a cold-welded connection, in particular a gas-tight connection. The connection between the first end section 7.1 of the contact element 7 and the free end 2.1 of the electrical conductor 2 is preferably also a form-fitting connection.

In order to produce the connection between the electrical conductor 2 or the inner conductor of the cable 1 and the contact element 7, the first end section 7.1 is introduced into the end face 2.2 of the free end 2.1 of the electrical conductor 2. This is effected with such a high pressure and/or at such a high relative velocity that the first end section 7.1 of the contact element 7 and the electrical conductor 2 are connected to one another with a material bond at least in certain regions as a result of the high pressure and/or as a result of the high relative velocity.

The first end section 7.1 of the contact element 7 is preferably also introduced into the electrical conductor 2 in such a manner that the contact element 7 does not make contact with the outer circumference of the electrical conductor 2 if the first end section 7.1 is in its end position in the electrical conductor 2.

The end position is preferably an axial position in which the first end section 7.1 of the contact element 7 has completely penetrated the electrical conductor 2. However, it may also be an axial position in which the first end section 7.1 of the contact element 7 has not completely penetrated the electrical conductor 2 and a distance remains between the end face 2.2 of the free end 2.1 of the electrical conductor 2 and the middle section 7.2 of the contact element 7.

In particular, the free end 2.1 of the electrical conductor 2 is introduced into an end face 2.2 which is initially still completely closed and is penetrated only by the introduction of the first end section 7.1 of the contact element 7. Therefore, a hole in the end face 2.2 is not absolutely necessary. In principle, however, a hole, in particular a centering hole, can also be provided.

The first end section 7.1 of the contact element 7 can be introduced into the free end 2.1 of the electrical conductor 2 at a relative velocity of at least 5 m/s, preferably at least 10 m/s, particularly preferably at least 20 m/s, more preferably at least 30 m/s, and very particularly preferably at least 40 m/s.

In order to further improve the mechanical connection, in particular in order to optimize a connection with a material bond, a rotary movement of the contact element 7 can be superimposed on an axial movement in the axial direction, which extends along a longitudinal axis L of the electrical cable 1, when introducing the first end section 7.1 of the contact element 7 into the electrical conductor 2. The corresponding frictional energy can facilitate the production of a connection with a material bond.

In order to produce the connection arrangement 6, provision may be made of an apparatus 9 having means in order to introduce the first end section 7.1 of the contact element into the end face 2.2 of the free end 2.1 of the electrical conductor 2 with a material bond at least in certain regions at high velocity and/or with high mechanical force. An exemplary apparatus 9 indicated only schematically is illustrated in FIG. 13.

The means can be in the form of pneumatic, electromagnetic, pyrotechnic or gravitation-based means in order to sufficiently accelerate the contact element 7. Provision may also be made for a means driven by spring force to insert the first end section 7.1 of the contact element 7 into the end face 2.2 of the free end 2.1 of the electrical conductor 2. The means however are not limited to pneumatic, electromagnetic, pyrotechnic, gravitation-based, nor spring force, and other means are similarly contemplated so as to generate the desired result.

FIG. 13 illustrates, by way of example, an apparatus 9 having a pneumatic means which is in the form of a compressed air cannon 10 for inserting the contact element 7.

In order to facilitate the penetration of the contact element 7 or the front end section 7.1 of the contact element 7 into the end face 2.2 of the electrical conductor 2, different geometries of the first end section 7.1 can be provided.

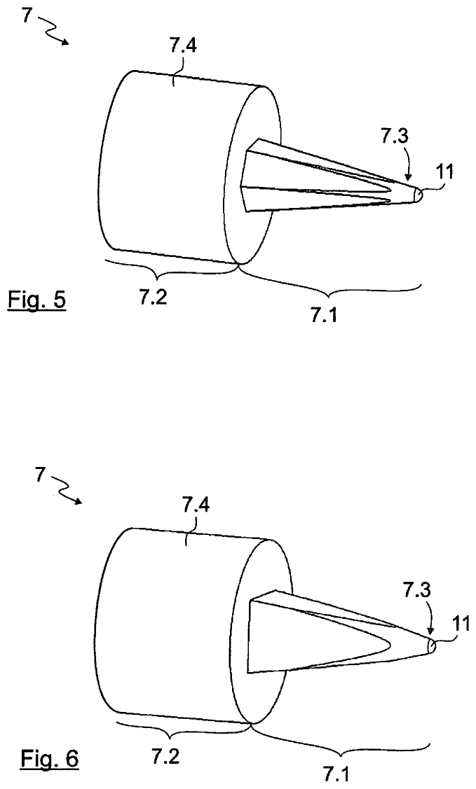

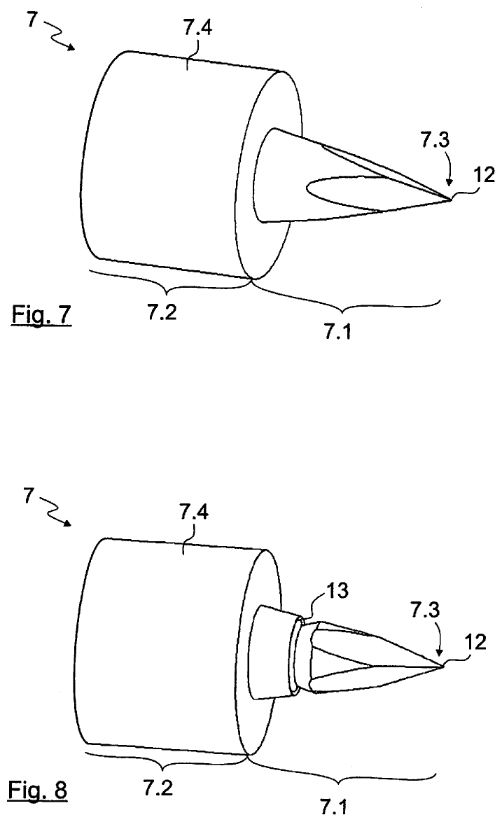

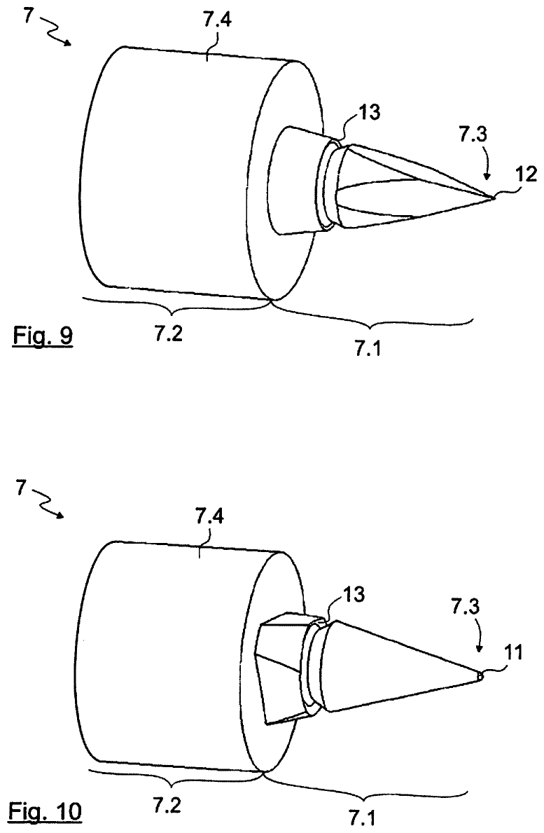

In particular, provision may be made for the cross section of the first end section 7.1 to taper in the direction of the free end 7.3 of the first end section 7.1, in particular for the first end section 7.1 of the contact element 7 to be conically shaped. A corresponding configuration is illustrated in all exemplary embodiments in FIGS. 2 to 12. In particular, the exemplary embodiments shown in FIGS. 5 to 7 show different variants of an advantageous conical shape of the first end section.

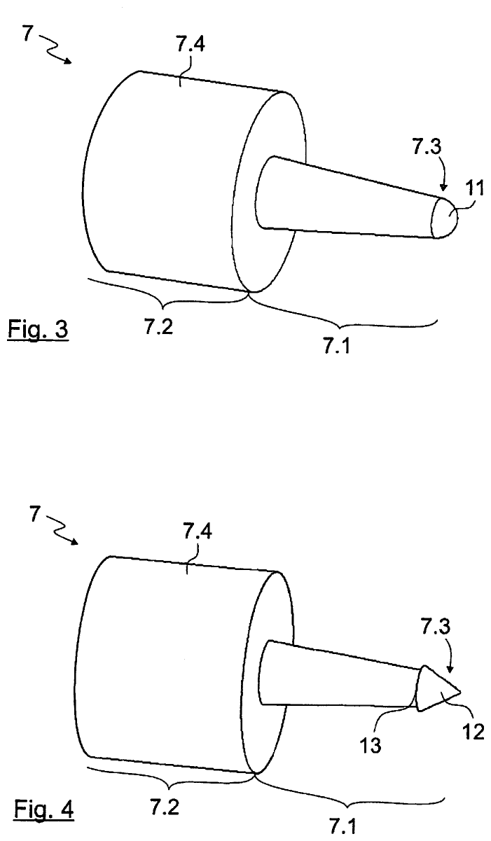

The free end 7.3 of the first end section 7.1 of the contact element 7 may have, for example, a curvature 11 (cf., for example, FIG. 3) or a tip 12 (cf., for example, FIG. 4).

In particular, in order to facilitate a form-fitting connection, the first end section 7.1 of the contact element 7 may have at least one radial shoulder 13, preferably at least one radial cutting edge 14 and/or an undercut 15. The exemplary embodiments in FIGS. 8 to 11 show, by way of example, different variants with corresponding radial shoulders 13 which make it possible for the contact element 7 to hook into the electrical conductor 2. A tip 12 of the free end 7.3, as shown in the exemplary embodiment in FIG. 4, can also have a corresponding radial shoulder 13.

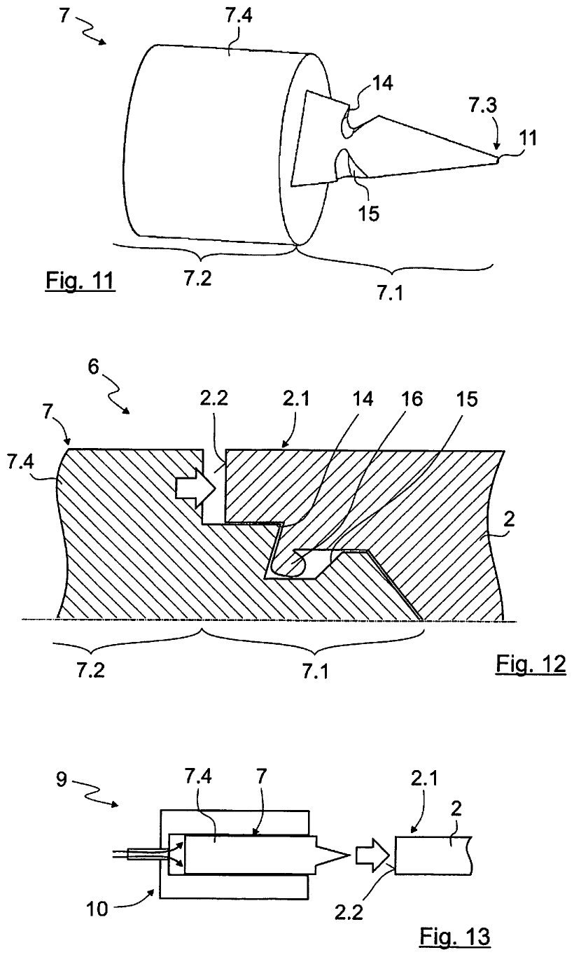

FIG. 11 shows an embodiment of the invention in which a radial cutting edge 14 with an undercut 15 is provided. FIG. 12 shows an enlarged section in a sectional illustration. A chip 16 of the electrical conductor 2 can be completely or partially abraded by means of the cutting edge 14. The chip 16 can then be conveyed into the undercut 15, thus making it possible to produce and optimize a form-fitting connection and/or a connection with a material bond.

Provision may also be made for the first end section 7.1 of the contact element 7 to have a coating, preferably a coating made of a material with a lower melting temperature than that of the material of the contact element 7 and that of the material of the electrical conductor 2. For example, it is possible to provide a silver coating which is applied to a contact element 7 formed from brass.

### Operation

A first object of the present invention is a connection arrangement (6) comprising an electrical cable (1) and a contact element (7) connected to a free end (2.1) of an electrical conductor (2) of the electrical cable (1), wherein a first end section (7.1) of the contact element (7) penetrates an end face (2.2) of the free end (2.1) of the electrical conductor (2), characterized in that at least one region of the first end section (7.1) of the contact element (7) is directly connected to the electrical conductor (2) with a material bond.

A second object of the present invention is a connection arrangement (6) according to claim 1, characterized in that the contact element (7) is connected to the free end (2.1) of the electrical conductor (2) in such a manner that the contact element (7) does not make contact with an outer circumference of the electrical conductor (2).

A third object of the present invention is a connection arrangement (6) according to claim 1 or 2, characterized in that the electrical conductor (2) is in the form of an inner conductor of the cable (1) and the contact element (7) is in the form of an inner conductor contact element of a plug connector (5).

A fourth object of the present invention is a connection arrangement (6) according to one of claims 1 to 3, characterized in that the outer diameter of the contact element (7) corresponds to the outer diameter of the electrical conductor (2) in a middle section (7.2) adjoining the first end section (7.1) of the contact element (7).

A fifth object of the present invention is a connection arrangement (6) according to one of claims 1 to 4, characterized in that the connection between the first end section (7.1) of the contact element (7) and the free end (2.1) of the electrical conductor (2) is a cold-welded connection, preferably a gas-tight connection.

A sixth object of the present invention is a connection arrangement (6) according to one of claims 1 to 5, characterized in that the cross section of the first end section (7.1) tapers in the direction of the free end (2.1) of the first end section (7.1).

A seventh object of the present invention is a connection arrangement (6) according to one of claims 1 to 6, characterized in that the first end section (7.1) of the contact element (7) has at least one radial shoulder (13), preferably at least one radial cutting edge (14) and/or an undercut (15).

An eighth object of the present invention is a connection arrangement (6) according to one of claims 1 to 7, characterized in that the first end section (7.1) of the contact element (7) has a coating.

A ninth object of the present invention is a contact element (7) for connection to a free end (2.1) of an electrical conductor (2) of an electrical cable (1), having a contact body (7.4) with a first end section (7.1), wherein the first end section (7.1) is configured to penetrate an end face (2.2) of the free end (2.1) of the electrical conductor (2), characterized in that at least one section of the first end section (7.1) of the contact body (7.4) can be directly connected to the first conductor (2) with a material bond.

A tenth object of the present invention is an electrical plug connector (5) comprising a connection arrangement (6) according to one of claims 1 to 8.

An eleventh object of the present invention is a method for producing a connection between an electrical conductor (2) of an electrical cable (1) and a contact element (7), according to which a first end section (7.1) of the contact element (7) is introduced into an end face (2.2) of a free end (2.1) of the electrical conductor (2), characterized in that the first end section (7.1) of the contact element (7) is introduced into the free end (2.1) of the electrical conductor (2) with such a high pressure and/or at such a high relative velocity that the first end section (7.1) of the contact element (7) and the electrical conductor (2) are connected to one another with a material bond at least in certain regions as a result of the high pressure and/or the high relative velocity.

A twelfth object of the present invention is a method according to claim 11, characterized in that the high relative velocity is based on a high linear velocity and/or a high angular velocity.

A thirteenth object of the present invention is a method according to claim 11 or 12, characterized in that the contact element (7) is introduced into the free end (2.1) of the electrical conductor (2) in such a manner that the contact element (7) does not make contact with an outer circumference of the electrical conductor (2) if the first end section (7.1) is in its end position in the electrical conductor (2).

A fourteenth object of the present invention is a method according to one of claims 11 to 13, characterized in that the free end (2.1) of the electrical conductor (2) forms a completely closed end face (2.2) which is penetrated by introducing the first end section (7.1) of the contact element (7).

A fifteenth object of the present invention is an apparatus (9) for producing a connection arrangement (6) according to one of claims 1 to 8, characterized in that means (10) are provided for the purpose of introducing the first end section (7.1) of the contact element (7) into an end face (2.2) of the free end (2.1) of the electrical conductor (2) with a material bond at least in certain regions at high velocity and/or with high mechanical force.

A sixteenth object of the present invention is a connection arrangement (6) comprising an electrical cable (1) having an electrical conductor 2; a contact element (7) connected to a free end (2.1) of the electrical conductor (2) of the electrical cable (1), and wherein a first end section (7.1) of the contact element (7) penetrates an end face (2.2) of the free end (2.1) of the electrical conductor 2; and at least one region of the first end section (7.1) of the contact element (7) is directly connected to the electrical conductor (2) with a material bond.

A seventeenth object of the present invention is a connection arrangement (6) wherein the contact element (7) is connected to the free end (2.1) of the electrical conductor (2) in such a manner that the contact element (7) does not make contact with an outer circumference of the electrical conductor (2).

An eighteenth object of the present invention is a connection arrangement (6) wherein the electrical conductor (2) is in the form of an inner conductor of the cable, (1) and the contact element (7) is in the form of an inner conductor contact element of a plug connector (5).

A nineteenth object of the present invention is a connection arrangement (6) wherein an outer diameter of the contact element (7) corresponds to an outer diameter of the electrical conductor (2) in a middle section (7.2) adjoining the first end section (7.1) of the contact element (7).

A twentieth object of the present invention is a connection arrangement (6) wherein the connection between the first end section (7.1) of the contact element (7) and the free end (2.1) of the electrical conductor (2) is a cold-welded connection.

A twenty first object of the present invention is a connection arrangement (6) wherein a cross section of the first end section (7.1) tapers in the direction of the free end (2.1) of the first end section (7.1).

A twenty second object of the present invention is a connection arrangement (6) wherein the first end section (7.1) of the contact element (7) has at least one radial shoulder (13).

A twenty third object of the present invention is a connection arrangement (6) further comprising: a coating on the contact element (7).

A twenty fourth object of the present invention is a contact element (7) for connection to a free end (2.1) of an electrical conductor (2) of an electrical cable comprising: the contact element (1), having a contact body (7.4) with a first end section (7.1), and wherein the first end section (7.1) is configured to penetrate an end face (2.2) of the free end (2.1) of the electrical conductor (2); and wherein at least one section of the first end section (7.1) of the contact body (7.4) is directly connected to the first conductor (2) with a material bond.

A twenty fifth object of the present invention is a method for producing a connection between an electrical conductor (2) of an electrical cable (1) and a contact element (7), the method comprising the steps: providing a contact element having a first end section; introducing the first end section (7.1) of the contact element (7) into an end face (2.2) of a free end (2.1) of the electrical conductor (2); and introducing the first end section (7.1) of the contact element (7) into the free end (2.1) of the electrical conductor (2) with high pressure and high relative velocity so that the first end section (7.1) of the contact element (7) and the electrical conductor (2) are connected to one another with a material bond, at least in certain regions, as a result of the high pressure and the high relative velocity.

A twenty sixth object of the present invention is a method wherein the high relative velocity is based on a high linear velocity and/or a high angular velocity.

A twenty seventh object of the present invention is a method wherein the contact element (7) is introduced into the free end (2.1) of the electrical conductor (2) in such a manner that the contact element (7) does not make contact with an outer circumference of the electrical conductor (2) when the first end section (7.1) is in position in the electrical conductor (2).

A twenty eighth object of the present invention is a method and wherein the free end (2.1) of the electrical conductor (2) forms a completely closed end face (2.2) that is penetrated by introducing the first end section (7.1) of the contact element (7).

A twenty ninth object of the present invention is a method further comprising: the steps of introducing the first end section (7.1) of the contact element (7) into an end face (2.2) of the free end (2.1) of the electrical conductor (2) with a material bond, at least in certain regions, at high velocity and/or with high mechanical force.

A thirtieth object of the present invention is a connection arrangement wherein the connection between the first end section (7.1) of the contact element (7) and the free end (2.1) of the electrical conductor (2) is a gas-tight connection.

A thirty first object of the present invention is a connection arrangement (6) wherein the first end section (7.1) of the contact element (7) has at least one radial cutting edge (14).

A thirty second object of the present invention is a connection arrangement (6) wherein the first end section (7.1) of the contact element (7) has at least one radial shoulder (13) and an undercut (15).

A thirty third object of the present invention is a method wherein the material bond created by introducing the first end section (7.1) of the contact element (7) into an end face (2.2) of the free end (2.1) of the electrical conductor (2) is accomplished with high mechanical force.

A thirty fourth object of the present invention is a method and wherein the material bond created by introducing the first end section (7.1) of the contact element (7) into an end face (2.2) of the free end (2.1) of the electrical conductor (2) is accomplished with high velocity and high mechanical force.

We claim:

1. A connection arrangement comprising:
an electrical cable having an electrical conductor;
a contact element connected to a free end of the electrical conductor of the electrical cable, and wherein a first end section of the contact element penetrates an end face of the free end of the electrical conductor; and
at least one region of the first end section of the contact element is directly connected to the electrical conductor with a material bond.

2. The connection arrangement of claim 1 and wherein the contact element is connected to the free end of the electrical conductor in such a manner that the contact element does not make contact with an outer circumference of the electrical conductor.

3. The connection arrangement of claim 1 and wherein the electrical conductor is in the form of an inner conductor of the cable, and the contact element is in the form of an inner conductor contact element of a plug connector.

4. The connection arrangement of claim 1 and wherein an outer diameter of the contact element corresponds to an outer diameter of the electrical conductor in a middle section adjoining the first end section of the contact element.

5. The connection arrangement of claim 1 and wherein the connection between the first end section of the contact element and the free end of the electrical conductor is a cold-welded connection.

6. The connection arrangement of claim 1 and wherein a cross section of the first end section tapers in the direction of the free end of the first end section.

7. The connection arrangement of claim 1 and wherein the first end section of the contact element has at least one radial shoulder.

8. The connection arrangement of claim 1 and further comprising:
a coating on the contact element.

9. A contact element for connection to a free end of an electrical conductor of an electrical cable comprising:
the contact element, having a contact body with a first end section, and wherein the first end section is configured to penetrate an end face of the free end of the electrical conductor; and wherein at least one section of the first end section of the contact body is directly connected to the first conductor with a material bond.

10. (canceled)

11. A method for producing a connection between an electrical conductor of an electrical cable and a contact element, the method comprising the steps:
providing a contact element having a first end section;
introducing the first end section of the contact element into an end face of a free end of the electrical conductor; and
the first end section of the contact element is introduced into the free end of the electrical conductor with high pressure and high relative velocity so that the first end section of the contact element and the electrical conductor are connected to one another with a material bond, at least in certain regions, as a result of the high pressure and the high relative velocity.

12. The method of claim 11 and wherein the high relative velocity is based on a high linear velocity and/or a high angular velocity.

13. The method of claim 11 and wherein the contact element is introduced into the free end of the electrical conductor in such a manner that the contact element does not make contact with an outer circumference of the electrical conductor when the first end section is in position in the electrical conductor.

14. The method of claim 11 and wherein the free end of the electrical conductor forms a completely closed end face that is penetrated by introducing the first end section of the contact element.

15. The method of claim 11 and further comprising:
introducing the first end section of the contact element into an end face of the free end of the electrical conductor with a material bond, at least in certain regions, at high velocity and/or with high mechanical force.

16. The connection arrangement of claim 1 and wherein the connection between the first end section of the contact element and the free end of the electrical conductor is a gas-tight connection.

17. The connection arrangement of claim 1 and wherein the first end section of the contact element has at least one radial cutting edge.

18. The connection arrangement of claim 1 and wherein the first end section of the contact element has at least one radial shoulder and an undercut.

19. The method of claim 15 and wherein the material bond created by introducing the first end section of the contact element into an end face of the free end of the electrical conductor is accomplished with high mechanical force.

20. The method of claim 15 and wherein the material bond created by introducing the first end section of the contact element into an end face of the free end of the electrical conductor is accomplished with high velocity and high mechanical force.
